(19) United States
(12) Patent Application Publication
(10) Pub. No.: US 2013/0052491 A1
(43) Pub. Date: Feb. 28, 2013

(54) THERMAL MANAGEMENT SYSTEM FOR A MULTI-CELL ARRAY

(71) Applicants: Roger Neil Bull, Etwall (GB); Paul Sudworth, Ashby de la Zouch (GB); Stuart Martin Towle, Spondon (GB)

(72) Inventors: Roger Neil Bull, Etwall (GB); Paul Sudworth, Ashby de la Zouch (GB); Stuart Martin Towle, Spondon (GB)

(21) Appl. No.: 13/219,173

(22) Filed: Aug. 26, 2011

(51) Int. Cl. H01M 10/50; H01M 2/02

(52) U.S. Cl. 429/50; 429/120

(57) ABSTRACT

A thermal management system for an energy storage system that controls the temperature of an array of electrochemical cells of the energy storage system. Fluid channels or pathways are provided around outer side regions of an array of electrochemical cells. Fluid flow is directed along one pathway to a next subsequent pathway, absorbing thermal energy generated by the array of electrochemical cells along the way. The fluid flow is eventually discharged from the energy storage system by the thermal management system, thereby removing thermal energy from the energy storage system.

### BACKGROUND

1. Technical Field

The subject matter disclosed herein relates to batteries and, more particularly, to a thermal management system for a battery having an array of electrochemical cells.

2. Discussion of Art

Multi-celled batteries for storing energy are sensitive to temperature and may operate more effectively at a particular temperature or within a particular temperature range. Current methods of thermally managing multi-celled batteries often employ an excessive amount of material within the battery, for example in the form of cooling panels between rows of electrochemical cells which have to be tied together using manifolds. Such methods can add significant cost and weight to the battery.

It would therefore be desirable to develop a battery with thermal management features and characteristics that differ from those of batteries that are currently available.

### BRIEF DESCRIPTION

In an embodiment, a thermal management system is provided having a first air-flow channel configured to be disposed along a first inner side region of a housing for an array of electrochemical cells, and having a first air inlet end and a first air outlet end. The thermal management system also provides a second air-flow channel configured to be disposed along a second inner side region of the housing that is perpendicular to the first inner side region, and having a second air inlet end configured to be fluidly coupled to the first air outlet end, and having a second air outlet end. The thermal management system further provides a third air-flow channel configured to be disposed along a third inner side region of the housing that is perpendicular to the second inner side region, and having a third air inlet end configured to be fluidly coupled to the second air outlet end, and having a third air outlet end.

In an embodiment, an energy storage system is provided having an enclosure having a plurality of internal surfaces that define a volume, an array of electrochemical cells disposed within the enclosure volume, and the thermal management system defined above, operable to control a temperature of the array of electrochemical cells in the enclosure.

In an embodiment, a method is provided including directing an air flow along a first air-flow pathway that is disposed along a first inner side portion of a housing for a plurality of electrochemical cells. The method also includes redirecting at least a portion of the air flow from the first air-flow pathway to a second air-flow pathway that is perpendicular to the first air-flow pathway. The second air-flow pathway is disposed along a second inner side portion of the housing. The method further includes redirecting at least a portion of the air flow from the second air-flow pathway to a third air-flow pathway that is perpendicular to the second air-flow pathway. The third air-flow pathway is disposed along an outer side region adjacent to the plurality of electrochemical cells.

In an embodiment, a thermal management system for an electrochemical device is provided having means for directing an air flow along a first outer side region adjacent to a plurality of electrochemical cells to remove thermal energy generated, at least in part, by the plurality of electrochemical cells. The thermal management system also has means for redirecting at least a portion of the air flow from along the first outer side region to along a second outer side region adjacent to the plurality of electrochemical cells that is perpendicular to the first outer side region to further remove thermal energy generated, at least in part, by the plurality of electrochemical cells. The thermal management system further has means for redirecting at least a portion of the air flow from along the second outer side region to along a third outer side region adjacent to the plurality of electrochemical cells that is perpendicular to the second outer side region to further remove thermal energy generated, at least in part, by the plurality of electrochemical cells.

In an embodiment, a system is provided having a housing with an interior surface that defines a volume, and the interior surface has a base portion that is spaced from a ceiling portion by one or more side surface portions, and the housing has an orientation such that the ceiling portion is relatively above the base portion. The system also has an array of electrochemical cells disposed in the housing volume that are operable to generate heat, each electrochemical cell of the array is elongate and has a first end and a second end, and the first ends are proximate to but spaced from the base portion, and the second ends are proximate to but spaced from the ceiling portion. The system further has a coolant source that is operable to flow a coolant through a first channel that is disposed between the base portion and the first ends, and further operable to flow the coolant subsequently through a third channel that is disposed between the ceiling portion and the second ends.

### BRIEF DESCRIPTION OF THE DRAWINGS

Reference is made to the accompanying drawings in which particular embodiments of the invention are illustrated as described in more detail in the description below, in which:

FIG. 1 illustrates the broad concept of an energy storage system having a thermal management system, in accordance with various embodiments;

FIG. 2 is an embodiment of an energy storage system having a thermal management system;

FIG. 3 is an embodiment of a system having the energy storage system of FIG. 2, a coolant source, and an outlet bellows;

FIG. 4 is a first perspective view of an embodiment of a portion of the thermal management system of FIG. 2;

FIG. 5 is a second perspective view of an embodiment of a portion of the thermal management system of FIG. 2;

FIG. 6 is a front view of an embodiment of a portion of the thermal management system of FIG. 2;

FIG. 7 is a side view of an embodiment of a portion of the thermal management system of FIG. 2;

FIG. 8 is a top view of an embodiment of a portion of the thermal management system of FIG. 2; and

FIG. 9 is a flowchart of an embodiment of a method of thermally managing the energy storage system of FIG. 2 using the portion of the thermal management system of FIGS. 4-8.

### DETAILED DESCRIPTION

Embodiments relate to a thermal management system for an energy storage system. With reference to the drawings, like reference numerals designate identical or corresponding parts throughout the several views. However, the inclusion of like elements in different views does not mean a given embodiment necessarily includes such elements or that all embodiments of the invention include such elements.

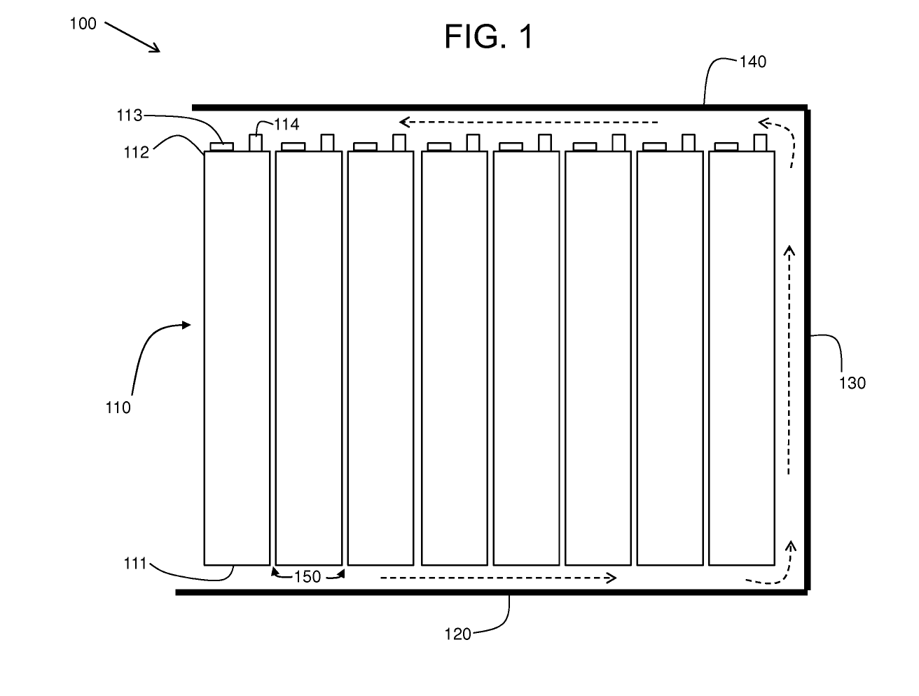

FIG. 1 illustrates the broad concept of an energy storage system 100 having a thermal management system, in accordance with various embodiments. The thermal management system has several elements as is discussed herein. The energy storage system 100 includes a plurality of electrochemical cells 110 for storing energy. The electrochemical cells 110 are arranged adjacent to each other to form an array of electrochemical cells 110. For example, in accordance with an embodiment, sixty-four electrochemical cells 110 can be arranged as an array of eight cells by eight cells in, for example, a generally cubic (rectangular parallelepiped) configuration. Each electrochemical cell has a first end 111 and a second end 112, as defined in this example, by the longitudinal axis of the cell. Furthermore, each electrochemical cell includes a negative electrical terminal 113 and a positive electrical terminal 114 on the second end 112. The electrical terminals of the cells may be connected in series, in parallel, or in some combination of series and parallel connections between adjacent cells, depending on the application.

Typical embodiments of such electrochemical cells can have dimensions of about 37 mm×27 mm×240 mm, any of which dimensions may vary by up to +/−50%, in accordance with various embodiments. The chemistry of a typical cell is of the sodium-metal-halide type, where NaCl and Ni are converted to Na and NiCl₂ during battery charging. The energy capacity of a cell can range from about 30 amp*hours to about 250 amp*hours.

An array of cells can be packaged into a housing to form a battery having typical dimensions of about 400 mm×500 mm×300 mm, any of which dimensions may vary by up to +/−50%, in accordance with various embodiments. In accordance with various embodiments, cooling channels are provided within the battery having a height ranging from about 2 mm to about 50 mm. Similarly, the width of a cooling channel can range from about 2 mm to about 50 mm. The operating temperature range of the cells can range between about 270° C. and about 350° C., in accordance with various embodiments.

The array of electrochemical cells 110 generates heat or thermal energy during operation. In accordance with an embodiment, the build-up of thermal energy and, therefore, the operating temperature of the cells 110 are controlled by providing a thermal management system that facilitates the flow of air (or other coolant) along a first air-flow channel 120 (e.g., under the cells), a second air-flow channel 130 (e.g., up the back of the cells), and a third air-flow channel 140 (e.g., over the top of the cells) along outer side regions defined by the array of cells 110. The term “channel” refers to a structure that defines a pathway or passageway for the passage of air or other coolant. The flow of air along the pathways of the channels, as indicated by the dashed arrows in FIG. 1, serves to remove thermal energy from the energy storage system 100. A cubic array of cells defines six distinct outer side regions. For example, an array of cells can define a bottom outer side region, a top outer side region, a front outer side region, a back outer side region, a left outer side region, and a right outer side region.

As shown in FIG. 1, the air flow along the first air-flow channel 120 fluidly couples to the second air-flow channel 130 which then fluidly couples to the third air-flow channel 140. As FIG. 1 shows a side-view of an array of electrochemical cells 110 along one dimension of the array, it is to be understood that air flow is channeled over the entire depth (i.e., into the page of FIG. 1) of the array of cells 110, in accordance with various embodiments. By concentrating the flow of air around the outer perimeter (i.e., the outer side regions) of the array of cells 110, additional elements such as, for example, cooling panels between rows of electrochemical cells (tied together using manifolds) are not employed, helping to reduce weight and cost of the energy storage device 100.

The cooling efficiency of the thermal management system of FIG. 1 may be reduced, compared to a more conventional system employing cooling panels between rows of cells, or other techniques which add weight and cost. This may limit the energy storage system 100 to low discharge rate applications such as uninterruptible power supply (UPS) applications and telecommunications applications, for example.

However, the cells 110 and the spatial relationship of the cells 110 to each other can be configured to allow gaps 150 to exist between the cells 110, for example, at the corners of the cells 110. As a result, a portion of the air flow can be directed upward between the cells directly from the first air-flow channel 120 toward the third air-flow channel 140 without the use of additional material or panels. Such inter-cell air flow can help to improve the cooling efficiency of the thermal management system of the energy storage system 100.

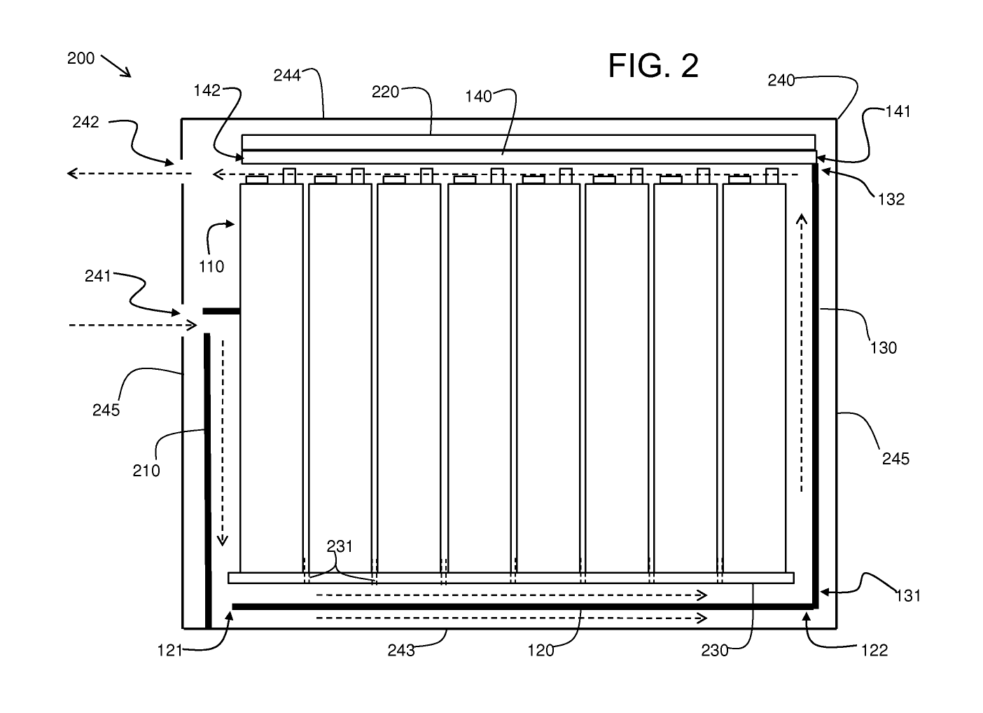

FIG. 2 illustrates an embodiment of an energy storage system 200 having the cells 110 of FIG. 1 and a thermal management system, including the air flow channels 120, 130, 140 of FIG. 1. Furthermore, the thermal management system includes an inlet air manifold 210.

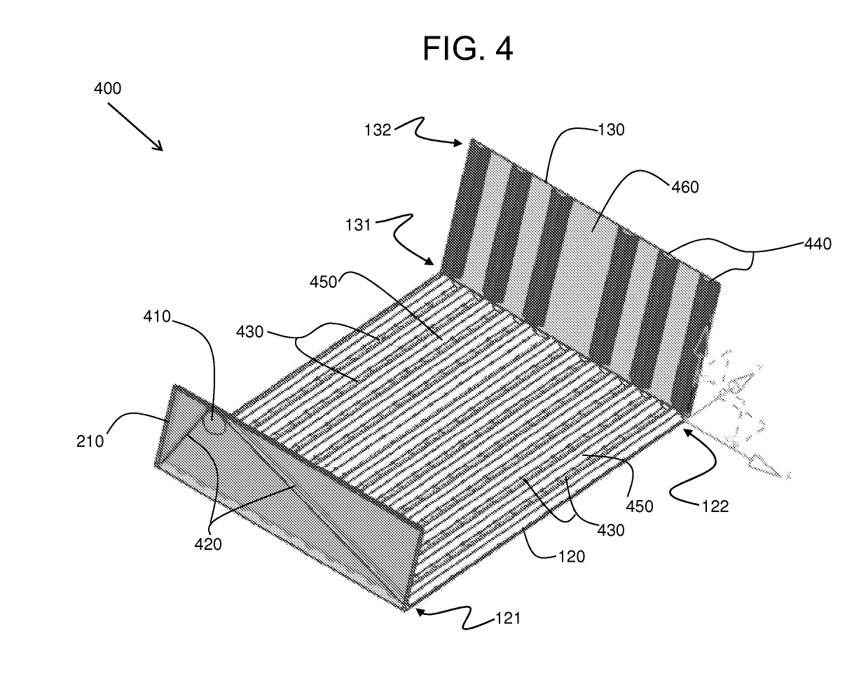

The first air-flow channel 120 has an air inlet end 121 and an air outlet end 122. The second air-flow channel 130 has an air inlet end 131 and an air outlet end 132. The third air-flow channel 140 has an air inlet end 141 and an air outlet end 142. In general, during operation, the path of air flow (see dashed arrows in FIG. 2) is into the inlet air manifold 210 and downward toward the air inlet end 121, across the first air-flow channel 120 toward the air inlet end 131, upward along the second air-flow channel 130 toward the air inlet end 141, and across the third air-flow channel 140 toward the air outlet end 142. In accordance with an embodiment, the first air-flow channel 120 is a corrugated structure, allowing air to effectively flow above and below the channel 120 (as indicated in FIG. 2). FIGS. 4, 5, and 8 illustrate the corrugated nature of the channel 120.

As air flows from channel to channel, more thermal energy is absorbed by the air, raising the temperature of the air as the air flows. Therefore, in general, the temperature of the air through the third air-flow channel 140 will be higher than the temperature of the air through the first air-flow channel 120.

In accordance with an embodiment, the third air-flow channel 140 is a sheet of mica material resting upon vertical mica sheets (not shown) residing between the cells 110 and extending upward just above the cell terminals 113 and 114, or resting upon a cranked portion (not shown) of one of the terminals of each of the cells, or resting on strips of mica (not shown) supported by flat intercell connectors on the cells, for example. During operation, air flows along the third air-flow channel 140 across the upper portions of the cells 110.

In accordance with an embodiment, the thermal management system of the energy storage system 200 further includes a heating element 220 adjacent to the third air-flow channel 140. The heating element 220 serves to input thermal energy (heat) into the energy storage system 200 to raise the temperature of the electrochemical cells 110 toward a desired operating temperature. Control of the heating element 220 and the air flow along the air-flow channels 120, 130, 140 provides overall thermal management of the energy storage system 200.

The energy storage system 200 of FIG. 2 includes a battery base 230 (e.g., a mica sheet) upon which the cells 110 sit. In accordance with an embodiment, the first air-flow channel 120 acts as a sump to support the cells on the battery base 230 while providing a region for air to flow beneath the battery base 230 and, therefore, beneath the cells 110. In this embodiment, the battery base 230 is made of a mica material and has a plurality of holes 231 therethrough. The plurality of holes 231 allow air to flow from the first air-flow channel 120, through the holes 231, and upward between the cells 110 (i.e., through the gaps 150) directly from the first air-flow channel 120 toward the third air-flow channel 140 without the use of additional material or panels. Such inter-cell air flow can help to improve the cooling efficiency of the thermal management system of the energy storage system 200. In accordance with an embodiment, a mica panel, stainless steel panel, and/or other panel can be positioned directly adjacent to each of the four sides of the array of cells 110 providing electrically insulating protection for the cells 110.

The energy storage system 200 also includes a housing or enclosure 240 (e.g., inner battery box) surrounding the electrochemical cells 110 and the various elements 120, 130, 140 and 210, 220, 230 of the thermal management system. The housing 240 defines an enclosed volume and has inner side regions (interior surfaces) and outer side regions (exterior surfaces). In accordance with an embodiment, the surfaces of the housing 240 define a base portion 243 that is spaced from a ceiling portion 244 by one or more side portions 245, where the ceiling portion 244 is relatively above the base portion 243. The housing 240 includes an input port 241 for the intake of air, and an output port 242 to remove air from the energy storage system 200.

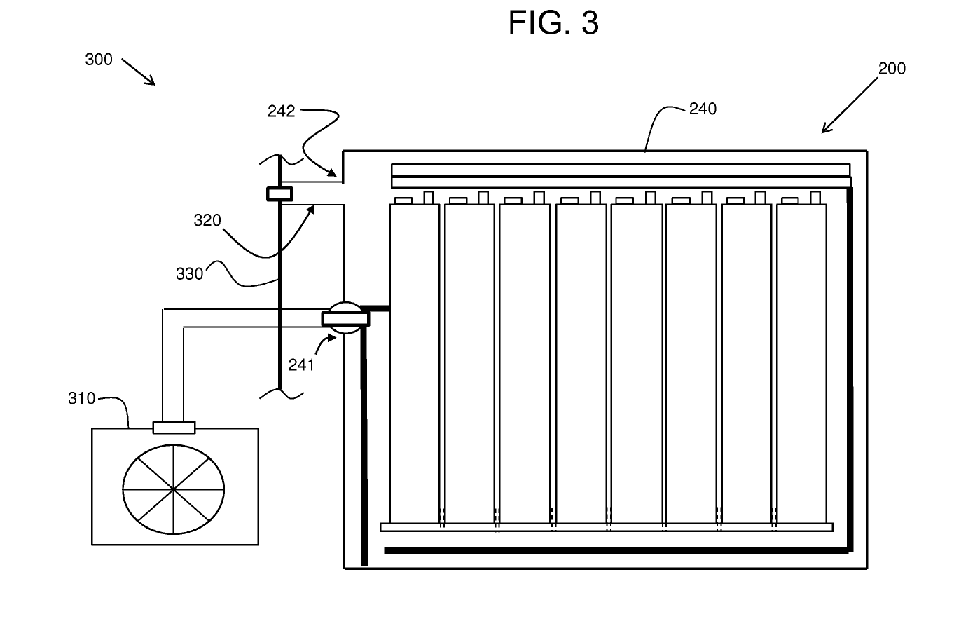

FIG. 3 is an embodiment of a system having the energy storage system 200 of FIG. 2, a coolant source 310, and an outlet bellows 320. In accordance with an embodiment, air flow is provided to the input port 241 from the coolant source 310 (e.g., an air blower or fan), and air is exited from the output port 242 via the outlet bellows 320. The outlet bellows 320 is made of stainless steel and/or mild steel. However, other materials can be used. The outlet bellows 320 connects between the inner battery box 240 and an outer battery housing 330, a portion of which is shown in FIG. 3. In accordance with an embodiment, a vacuum is pulled between the inner battery box 240 and the outer battery housing 330 to form an insulating space between them.

In accordance with an alternative embodiment, the thermal management system of the energy storage system 200 may be configured to use some other coolant instead of air such as, for example, an inert gas (e.g., argon or neon) or a liquid fluid (e.g., a water or an alcohol solution). In such an alternative embodiment, the flow of the fluid is still around the perimeter of the electrochemical cells 110 (e.g., along the bottom of the cells, then upward along the back of the cells, then across the top of the cells). In the case of a liquid fluid, the coolant source 310 can include a pump and the outlet bellows 320 can be replaced with a suction reservoir.

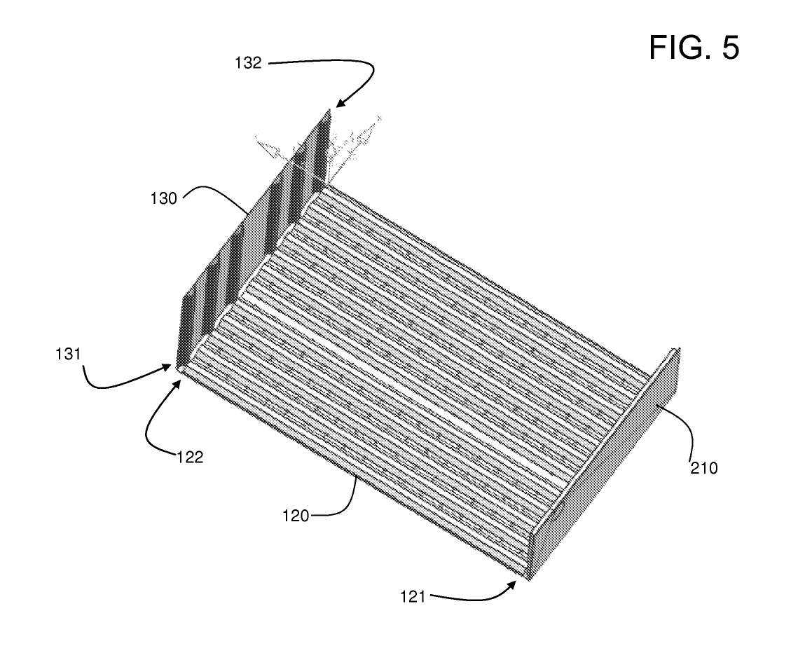

FIG. 4 is a first perspective view of an embodiment of a portion of the thermal management system of FIG. 2 including the inlet air manifold 210, the first air-flow channel 120, and the second air-flow channel 130. Similarly, FIG. 5 is a second perspective view of an embodiment of a portion of the thermal management system of FIG. 2. As shown in FIG. 4, the bottom end of the inlet air manifold 210 fits to the air inlet end 121 of the first air-flow channel 120. The inlet air manifold 210 is perpendicular to the first air-flow channel 120. Similarly, the air outlet end 122 of the first air-flow channel 120 fits to the air inlet end 131 of the second air-flow channel 130. The second air-flow channel 130 is perpendicular to the first air-flow channel 120 and parallel to the inlet air manifold 210. The corrugated nature of the first air-flow channel 120, in accordance with an embodiment, allows air to flow through the troughs 450 and peaks 430 formed by the corrugation such that air effectively flows above and below the channel 120 as shown in FIG. 2. The first air-flow channel 120 is made of stainless steel in accordance with an embodiment; however, other materials can be used.

An embodiment relates to a thermal management system. The system comprises means (see structure shown at least in FIGS. 2, 3, 4, 5, and 7) for directing an air flow along a first outer side region adjacent to a plurality of electrochemical cells to remove thermal energy generated, at least in part, by the plurality of electrochemical cells. The system also comprises means (see structure shown at least in FIGS. 2, 3, 4, 5, and 7) for redirecting at least a portion of the air flow from along the first outer side region to along a second outer side region adjacent to the plurality of electrochemical cells that is perpendicular to the first outer side region to further remove thermal energy generated, at least in part, by the plurality of electrochemical cells. The system further comprises means (see structure shown at least in FIGS. 2 and 3) for redirecting at least a portion of the air flow from along the second outer side region to along a third outer side region adjacent to the plurality of electrochemical cells that is perpendicular to the second outer side region to further remove thermal energy generated, at least in part, by the plurality of electrochemical cells.

In accordance with an embodiment, the first air-flow channel 120, the second air-flow channel 130, and the inlet air manifold 210 form an integrated structure 400 configured to be installed in the housing 240 as a single assembly. Alternatively, the first air-flow channel 120, the second air-flow channel 130, and the inlet air manifold 210 are configured to each be separately positioned into the housing 240. For example, the first air-flow channel 120 can be placed in the housing 240 first, followed by the second air-flow channel 130 where the inlet air end 131 is fit with the outlet air end 122, then followed by the inlet air manifold 210 where the bottom portion of the inlet air manifold 210 is fit with the inlet air end 121.

In accordance with an embodiment, air enters the inlet air manifold 210 at the inlet port 410 at the front of the energy storage system 200 and is directed downward toward the air inlet end 121 of the first air-flow channel 120 by a triangular section 420 of the inlet air manifold 210. As air enters the inlet port 410 at a top corner of the triangular section 420, the air is efficiently directed downward by the triangular section 420. The thickness of the inlet air manifold is about 10 millimeters, in accordance with an embodiment. The inlet air manifold 210 is made of mild steel, in accordance with an embodiment; however, other materials can be used.

In accordance with an embodiment, the second air-flow channel 130 includes a plurality of parallel spacer elements 440 running from the air inlet end 131 to the air outlet end 132. The spacer elements 440 provide an offset (e.g., about 10 millimeters) from the cells 110 at the back of the energy storage system 200, providing a space for air to flow upward along the second air-flow channel 130. The spacer elements 440 are attached to a side plate 460 of the second air-flow channel 130, or can be an integral part of the side plate 460. The second air-flow channel 130 is made of mild steel, in accordance with an embodiment; however, other materials can be used.

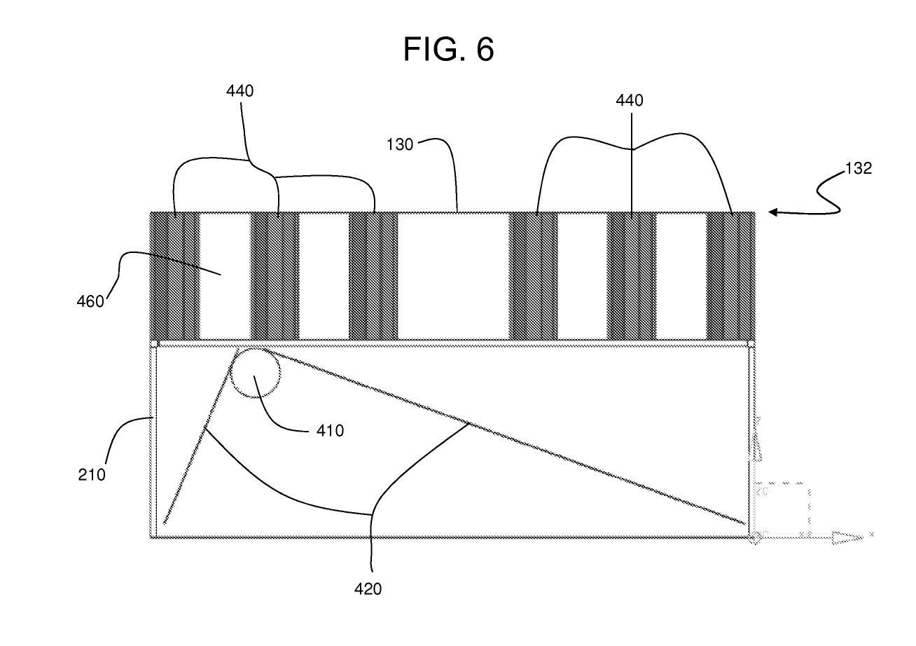

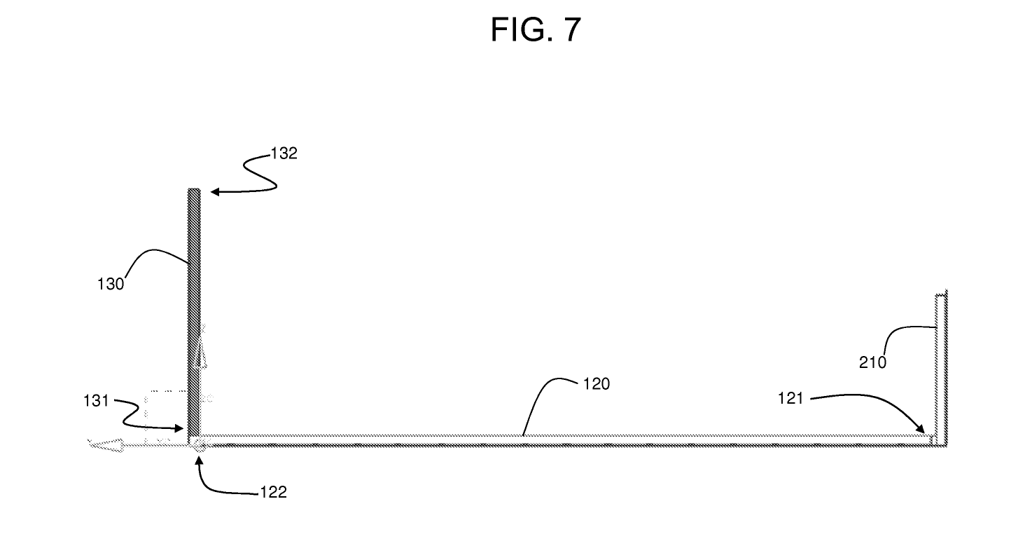

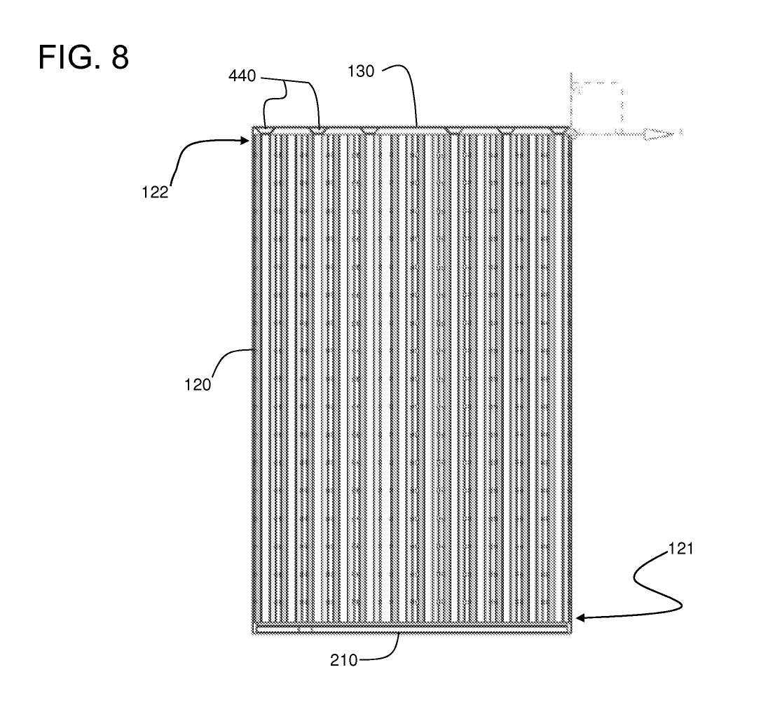

FIG. 6 is a front view of an embodiment of a portion of the thermal management system of FIG. 2. As can be seen in FIG. 6, the height of the inlet air manifold 210 is about two-thirds the height of the second air-flow channel 130, in accordance with an embodiment. FIG. 7 is a side view of an embodiment of a portion of the thermal management system of FIG. 2, and FIG. 8 is a top view of an embodiment of a portion of the thermal management system of FIG. 2.

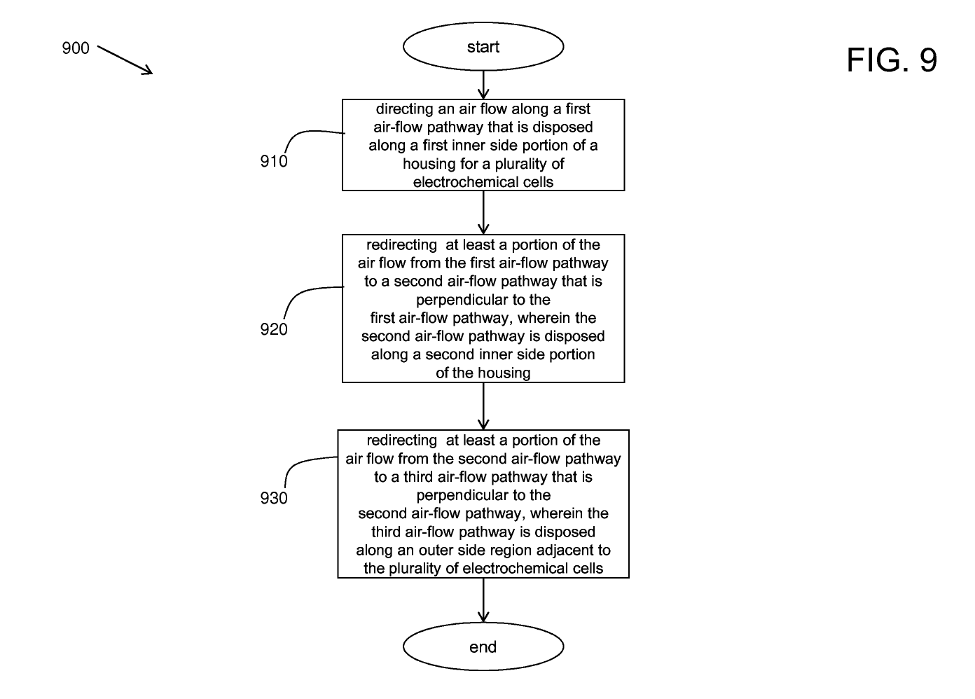

FIG. 9 is a flowchart of an embodiment of a method 900 of thermally managing the energy storage system 200 of FIG. 2 using the portion of the thermal management system of FIGS. 4-8. In step 910 of the method 900, air flow is directed along a first air-flow pathway 120 that is disposed along a first inner side portion of a housing 240 for a plurality of electrochemical cells 110. In step 920, at least a portion of the air flow is redirected from the first air-flow pathway 120 to a second air-flow pathway 130 that is perpendicular to the first air-flow pathway 120. The second air-flow pathway 130 is disposed along a second inner side portion of the housing 240. In step 930, at least a portion of the air flow is redirected from the second air-flow pathway 130 to a third air-flow pathway 140 that is perpendicular to the second air-flow pathway 130. The third air-flow pathway 140 is disposed along an outer side region adjacent to the plurality of electrochemical cells 110.

Referring to FIG. 3, in accordance with an embodiment, the air flow into the energy storage system 200 can be cycled on and off by the cooling source 310 according to a determined duty cycle. The duty cycle is controlled by the cooling source 310 to minimize temperature gradients across the energy storage system 200 while achieving cooling in a given time period, so as not to overcool the front of the energy storage system 200 with respect to the back of the energy storage system 200, for example.

During the manufacturing process of the electrochemical cells, the cells are heated as part of the manufacturing process. Before being shipped as a final energy storage product, the cells are put through a cool-down period to reduce the temperature of the cells. The thermal management system discussed herein can be used to cool down the cells, thus reducing the normal cool-down period, saving time and money, even if the end-user of the energy storage system (having the thermal management system) does not use the thermal management portion of the energy storage system in the field (e.g., in a low power telecommunications application).

Another embodiment relates to an energy storage system having a thermal management system. The energy storage system includes a plurality of electrochemical cells for storing energy, which are arranged into an array. (Dimensional and other aspects of the cells may be as described above.) The array is defined by six sides: a first pair (front, rear), a second pair (left, right), and a third pair (top, bottom). The sides of each pair are parallel to one another. Also, the sides of each pair are perpendicular and contiguous with the sides of the other pairs. The thermal management system includes a first channel that defines a first air flow region along the bottom side of the array. The thermal management system also includes a second channel that defines a second air flow region along the rear side of the array. The thermal management system also includes a third channel that defines a third air flow region along the top side of the array. (Dimensional aspects of the channels may be as described above.) The first air flow region is fluidly coupled with the second air flow region (and perpendicular thereto), and the second air flow region is fluidly coupled with the third air flow region (and perpendicular thereto). In operation, when air is urged through the first channel towards the rear side, the air flows through the first air flow region, is turned to flow through the second air flow region, and is turned to flow through the third air flow region, i.e., under, up the back, and back over the top of the array. There are no substantial air flow regions up the left and right sides, meaning there may be incidental gaps or spaces, but for a given flow rate through the first, second, and third channels, an incidental flow rate past the left and right sides is no more than 5%. In another embodiment, the thermal management system additionally includes an inlet member. The inlet member defines an air inlet, and is configured and positioned by the front side of the array to establish a fourth air flow region at the front side. The fourth air flow region is perpendicular and fluidly coupled to the first air flow region, such that when air is urged through the air inlet into the fourth air flow region, the air travels down the front of the front side of the air, and is turned for passing into the first air flow region. The inlet member is coupled to at least the first channel, and the channels are coupled to one another, as applicable, such that substantially all (at least 95%) of the air urged through the air inlet is directed through the fourth air flow region, then through the first, second, and third air flow regions in that order.

In any of the embodiments herein where elements are perpendicular, such elements may be generally perpendicular, meaning 90 degrees plus or minus 3 degrees, to account for relatively minor manufacturing variances/tolerances. Similarly, in any of the embodiments herein where elements are parallel, such elements may be generally parallel, meaning 0 degrees plus or minus 3 degrees, to account for relatively minor manufacturing variances/tolerances.

In the appended claims, the terms “including” and “having” are used as the plain language equivalents of the term “comprising”; the term “in which” is equivalent to “wherein.” Moreover, in the following claims, the terms “first,” “second,” “third,” “upper,” “lower,” “bottom,” “top,” etc. are used merely as labels, and are not intended to impose numerical or positional requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure. As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property. Moreover, certain embodiments may be shown as having like or similar elements, however, this is merely for illustration purposes, and such embodiments need not necessarily have the same elements unless specified in the claims.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

This written description uses examples to disclose the invention, including the best mode, and also to enable one of ordinary skill in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differentiate from the literal language of the claims, or if they include equivalent structural elements with insubstantial differences from the literal language of the claims.

What is claimed is:

1. A thermal management system, comprising:
a first air-flow channel configured to be disposed along a first inner side region of a housing for an array of electrochemical cells, and having a first air inlet end and a first air outlet end;
a second air-flow channel configured to be disposed along a second inner side region of the housing that is perpendicular to the first inner side region, and having a second air inlet end configured to be fluidly coupled to the first air outlet end, and having a second air outlet end; and
a third air-flow channel configured to be disposed along a third inner side region of the housing that is perpendicular to the second inner side region, and having a third air inlet end configured to be fluidly coupled to the second air outlet end, and having a third air outlet end.

2. The system according to claim 1, further comprising an inlet air manifold configured to be disposed along at least a portion of a fourth inner side region of the housing and further configured to be fluidly coupled to the first air inlet end.

3. The system according to claim 2, wherein the first air-flow channel, the second air-flow channel, and the inlet air manifold comprise an integrated structure configured to be installed in the housing as a single assembly.

4. The system according to claim 2, wherein the inlet air manifold includes a triangular section for directing airflow downward toward the first air inlet.

5. The system according to claim 2, wherein the inlet air manifold is made of at least mild steel.

6. The system according to claim 1, wherein the first air-flow channel includes a corrugated structure.

7. The system according to claim 1, further comprising an outlet bellows configured to be fluidly coupled to the third air outlet end.

8. The system according to claim 7, wherein the outlet bellows is made of at least one of stainless steel and mild steel.

9. The system according to claim 1, wherein the second air-flow channel includes a spacer made of at least mild steel.

10. An energy storage system, comprising:
an enclosure having a plurality of internal surfaces that define a volume;
an array of electrochemical cells disposed within the enclosure volume; and
the thermal management system defined in claim 1 operable to control a temperature of the array of electrochemical cells in the enclosure.

11. A method, comprising:
directing an air flow along a first air-flow pathway that is disposed along a first inner side portion of a housing for a plurality of electrochemical cells;
redirecting at least a portion of the air flow from the first air-flow pathway to a second air-flow pathway that is perpendicular to the first air-flow pathway, wherein the second air-flow pathway is disposed along a second inner side portion of the housing; and
redirecting at least a portion of the air flow from the second air-flow pathway to a third air-flow pathway that is perpendicular to the second air-flow pathway, wherein the third air-flow pathway is disposed along an outer side region adjacent to the plurality of electrochemical cells.

12. The method according to claim 11, further comprising directing the air flow into the first air-flow pathway via an inlet air manifold fluidly coupled to the first-air flow pathway and disposed along at least a part of a third inner side portion of the housing.

13. The method according to claim 12, further comprising discharging at least a portion of the air flow out of the third air-flow pathway and into an outlet bellows fluidly coupled to the third air-flow pathway.

14. The method according to claim 13, wherein the air flow is directed into the inlet air manifold by cycling the air flow on and off according to a determined duty cycle.

15. The method according to claim 14, wherein the duty cycle is controlled to minimize temperature gradients across the housing.

16. The method according to claim 15, further comprising directing a portion of the air flow from the first air-flow pathway directly toward the third air-flow pathway between the plurality of electrochemical cells without the aid of cooling panels between the plurality of electrochemical cells.

17. A thermal management system, comprising:
means for directing an air flow along a first outer side region adjacent to a plurality of electrochemical cells to remove thermal energy generated, at least in part, by the plurality of electrochemical cells;
means for redirecting at least a portion of the air flow from along the first outer side region to along a second outer side region adjacent to the plurality of electrochemical cells that is perpendicular to the first outer side region to further remove thermal energy generated, at least in part, by the plurality of electrochemical cells; and
means for redirecting at least a portion of the air flow from along the second outer side region to along a third outer side region adjacent to the plurality of electrochemical cells that is perpendicular to the second outer side region to further remove thermal energy generated, at least in part, by the plurality of electrochemical cells.

18. A system, comprising:
a housing with an interior surface that defines a volume, and the interior surface has a base portion that is spaced from a ceiling portion by one or more side surface portions, and the housing has an orientation such that the ceiling portion is relatively above the base portion;
an array of electrochemical cells disposed in the housing volume and that are operable to generate heat, each electrochemical cell of the array is elongate and has a first end and a second end, and the first ends are proximate to but spaced from the base portion, and the second ends are proximate to but spaced from the ceiling portion; and
a coolant source that is operable to flow a coolant through a first channel that is disposed between the base portion and the first ends, and further operable to flow the coolant subsequently through a third channel that is disposed between the ceiling portion and the second ends.

19. The system according to claim 18, wherein at least one of the side portions has an inlet that is coupled to the coolant source and to the first channel, and another one of the side portions is adjacent to at least a portion of a second channel that fluidly couples the first channel with the third channel.

20. The system according to claim 18, wherein coolant flowing through the first channel is warmed to a first temperature that is relatively lower than a second temperature of coolant flowing through the third channel.

21. The system according to claim 18, wherein the coolant source is configured to cycle the coolant on and off according to a determined duty cycle.

22. The system according to claim 21, wherein the duty cycle is determined to minimize temperature gradients across the array of electrochemical cells.
